(19) United States
(12) Patent Application Publication
(10) Pub. No.: US 2025/0251176 A1
(43) Pub. Date: Aug. 7, 2025

(54) Compositions and Methods to Form a Thermally Conductive Sheath

(71) Applicant: XGS Energy, Inc., Palo Alto, CA (US)

(72) Inventors: Axel-Pierre Bois, Curis-au-Mont-D’Or (FR); Denise Nicole Benoit, Houston, TX (US)

(73) Assignee: XGS Energy, Inc., Palo Alto, CA (US)

(21) Appl. No.: 19/047,205

(22) Filed: Feb. 6, 2025

Related U.S. Application Data
(60) Provisional application No. 63/550,937, filed on Feb. 7, 2024.
(60) Provisional application No. 63/550,959, filed on Feb. 7, 2024.

(51) Int. Cl. F24T 10/17; F24T 10/00; F24T 50/00

(52) U.S. Cl. CPC F24T 10/17; F24T 50/00; F24T 2010/50

(57) ABSTRACT

A high-thermal conductivity suspension is provided that comprises a high apparent viscosity carrier fluid and a plurality of high thermal conductivity particles. A system for using this high-thermal conductivity suspension to form a compacted high thermal conductivity sheath is also presented which comprises a step of settling the plurality of high thermal conductivity particles previously suspended in the high viscosity carrier fluid via viscosity breaking and a step of consolidating the settled plurality of particles via hydraulic or chemical consolidation. The resulting high thermal conductivity compacted sheath enhances heat transfer from a target location in a geological formation to a working fluid in a closed-loop heat harvester casing within a geothermal wellbore for electrical or thermal energy generation.

This application claims priority to co-pending US provisional patent applications with the Ser. No. 63/550,959, which was filed Feb. 7, 2024, and the Ser. No. 63/550,937, which was also filed Feb. 7, 2024, and which are both incorporated by reference herein.

### FIELD OF THE INVENTION

The field of the invention is improved compositions and systems of feeding a pumpable suspension, settling high thermal conductivity (k) materials from the pumpable suspension, and consolidating the high thermal k materials from the pumpable suspension to so form a compacted high thermal k sheath, especially as it relates to filling an annular space between a wellbore and a closed loop heat harvesting system.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

All publications and patent applications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Geothermal wells have been used to provide heating and cooling systems that transfer heat to and from the ground. In a typical vertical closed well loop system, two pipes joined by a U-shaped connector at the bottom, forming a continuous casing, are placed vertically in a wellbore drilled in a subterranean formation (see U.S. Pat. App. Pub. No. 2012/0247766). This type of system is generally used for heating and cooling residential and commercial buildings. In such systems, conventional grout mixtures are often clay-based and pumped into a wellbore to fill the annular space between the casing and the formation. The resulting grout forms a seal to prevent contamination of the subsurface from above ground, as well as to prevent groundwater contamination. The grout mixture may further include thermally conductive materials to aid in transferring heat between the working fluid in the casing and the target location, and a working fluid may be circulated through the well loop to transfer heat to and from a heat exchanger at the surface.

In many cases, conventional geothermal wells contain significant amounts of curable materials (e.g., cementitious materials) for hardening of the grout mixture. Unfortunately, these curable materials do not exhibit high-thermal conductivity, which leads to a significant portion of the grout composition lacking thermal conductivity at best, or acting as an insulator at worst, even when the grout composition contains some thermally conductive materials.

Thus, even though various compositions and methods for geothermal heat transfer are known in the art, all or almost all of them suffer from several drawbacks, particularly where materials lack high-thermal conductivity. Therefore, there remains a need for an improved material that is pumpable, thermally coupled to the geological formation and a casing within a wellbore, and that exhibits a higher coefficient of thermal conductivity than cement.

### SUMMARY OF THE INVENTION

The inventive subject matter is directed to various compositions and systems of settling and consolidating high thermal k materials from a pumpable suspension to form a compacted high thermal k sheath within an annular space between a wellbore and a closed loop heat harvesting system.

In one aspect of the inventive subject matter, the inventors contemplate a mixture comprising a suspended thermal reach enhancement (TRE) solid and a high apparent viscosity carrier fluid. The TRE solid is in the form of a plurality of TRE particles, which are suspended throughout the high apparent viscosity carrier fluid. The high apparent viscosity carrier fluid of the pumpable suspension has a composition that allows an additive or triggering event to change physical and/or chemical properties of the mixture in situ to thereby reduce viscosity and allow the particles to settle via gravity at a target location to form a settled particle sheath within an annular space of a wellbore. In addition, the TRE particles have a composition that allows consolidation of the settled particle sheath to form a high-thermal conductivity compacted sheath within the annular space of the wellbore.

In some embodiments, consolidation comprises hydraulic consolidation and/or chemical consolidation of the TRE particles.

Most typically, the plurality of TRE particles include materials selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, cobalt, copper alloys, nickel, iron, platinum, palladium, tin, steel, zirconium, titanium, carbon fiber, carbon black, and Hastelloy, and optionally wherein the TRE particles comprise at least two chemically distinct particles selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, cobalt, copper alloys, nickel, iron, platinum, palladium, tin, steel, zirconium, titanium, carbon fiber, carbon black, and Hastelloy.

It is further generally contemplated that the TRE particles have a shape selected from the group consisting of a platelet, a flake, a sphere, an irregular shape, a cube, a rod, a disc, a prism, a needle, a tube, a fiber, an angular shape, a subangular shape, a rounded shape, a subrounded shape, a dumbbell shape, and a star shape. Among other choices, a first portion and a second portion of the plurality of TRE particle will have a shape selected from this group, wherein the shape of the first and second portions are distinct.

In some embodiments, the first portion of the plurality of TRE particles have a composition and shape such that a mass of the first particles, upon compressional loading, deforms elastically and plastically, and wherein the second portion of the particles have a composition and shape such that a mass of the second particles, upon the compressional loading, deforms only elastically.

Preferably, but not necessarily, the plurality of TRE particles have D50 particle size of between 0.05 μm and 5.0 mm, and make up between 30 vol % and 70 vol % of the total suspension.

Most typically, the high apparent viscosity carrier fluid comprises a quantity of water. Yet where desired, the high apparent viscosity carrier fluid further comprises a water-soluble biopolymer, water-soluble derivatized biopolymer, water-soluble gum, water-soluble cellulose, a water-soluble synthetic polymer, or a surfactant, and optionally, wherein the gum, cellulose, polymer, biopolymer or surfactant in the carrier fluid forms a network, is crosslinked, or form a supramolecular structure. Additionally, the gum, cellulose, polymer, biopolymer or surfactant may bond to the TRE particles and form a suspended particle, a particle filled network, a crosslinked particle filled polymer network, and/or may form a particle filled supramolecular structure.

In additional embodiments, the high apparent viscosity carrier fluid also comprises a viscosity agent. Among other options, preferred viscosity agents include a guar gum, a polysaccharide (starch, guar, cellulose, cellulose derivatives, alginates, carrageenan, or locust gum), Xanthan, hydroxylethyl cellulose (HEC), a carboxymethyl guar (CMG), carboxymethyl hydroxylethyl cellulose (CMHEC) a hyperbranched polyglycerol (HPG), a carboxymethyl hydroxypropyl guar (CMHPG), a carboxymethyl cellulose (CMC), a high strength molding compound (HMC), an acrylamide, a poly (acrylamide/acrylic acid/2-acrylamido-2-methylpropane sulfonic acid) (AMPS-AA-AM), and a viscoelastic surfactant (VES). As will be appreciated, the viscosity agent may be present in an amount of between 0.01 and 20 wt % of the pumpable suspension.

Preferably, the high apparent viscosity carrier fluid has a composition that allows a reduction in apparent viscosity in response to a triggering event such as a chemical or enzymatic reaction (that reduces molecular weight/polymer chain length), increased temperature, change in reactivity, or pH, or time. Therefore, the high apparent viscosity carrier fluid may have a composition that allows reducing the viscosity with an additive selected from the group consisting of an oxidizer, a biobased enzyme, a bacterium, and a pH modifier, or that allows reducing the viscosity with a shear force or temperature change. Consequently, the additive may comprise between 0.001 and 10 wt % of the total suspension wt %. In addition, the additive may also modify the temperature stability of the pumpable suspension.

Suitable additives include a cross-linker additive, a dispersant additive, a breaker additive, and a stabilizer additive. For example, the cross-linker additive may be a metal antimony, aluminum, chromium, boron, titanium, or zirconium based; the dispersant additive may be a surfactant, a polymer, a salt, or a pH modifier; the breaker additive may be a pH modifier, an oxidizer, an enzyme, or a bacterium; the stabilizer additive may be an oxidizer. Moreover, the composition may also include at least two distinct additives.

In some embodiments, the cross-linker additive may be aluminum, chromium, metal antimony, boron, titanium, or zirconium based. The dispersant additive is contemplated to be a surfactant, a polymer, a salt, or a pH modifier. In other embodiments, the de-airing additive may be a polydimethylsiloxane, an alcohol, a stearate, a glycol, a surfactant, an alkylphenol ethoxylate, a silicone defoamer, a mineral oil defoamer, a vegetable oil defoamer, a wax-based defoamer, a polymer defoamer, or a silicone-free defoamer. Moreover, the breaker additive may be a pH modifier, an oxidizer, an enzyme, or a bacterium. Lastly, the stabilizer additive may be an oxidizer or a gel. Preferably, the composition may comprise at least two distinct additives.

It is generally contemplated that the pumpable suspension optionally further comprises a second additive that promotes the association of the plurality of TRE particles to a viscosity agent to thereby improve mixing and dispersion of the plurality of TRE particles within the high apparent viscosity carrier fluid. Alternatively, or additionally, the pumpable suspension optionally further comprises a second additive that breaks a polymer backbone or a polymer-polymer crosslink, optionally in response to the triggering event. In some embodiments, the pumpable suspension optionally further comprises a second additive that absorbs thermal energy to extend the usable temperature range for a given polymer by between 5° C. and 50° C.

Preferably, but not necessarily, the high apparent viscosity carrier fluid suspends the plurality of TRE particles until the viscosity of the carrier fluid is reduced by the triggering event in situ. In some embodiments, the high apparent viscosity carrier fluid has a dynamic viscosity, before the triggering event, of at least 5,000 centipoise (cP), and a dynamic viscosity, after the triggering event, of no more than 1,000 Cp. Most typically, the plurality of TRE particles have a size that allows settling of the TRE particles at least 1 m within 24 hours after reducing the viscosity. As a result, the settled particle sheath generally may have a final porosity of equal or less than 80% and a thermal conductivity of between about 1.5 W/mK and 400 W/mK. Subsequently, the settled particle sheath may then be consolidated to have a permeability of equal or less than 0.01 Darcy. In various embodiments, the resulting compacted sheath has a thermal conductivity of greater than 1.5 W/mK.

Viewed from another perspective, the inventors contemplate a system configured to transfer heat from a geological formation to a heat harvester casing. The contemplated system includes a heat harvester casing disposed in a wellbore that descends substantially vertically from a topside location to a target location in a geological formation, a thermal reach enhancement (TRE) structure at the target location that comprises a first high thermal k material, wherein the TRE structure extends from a wellbore distally into the geological formation at the target location, and wherein the TRE structure has a mouth portion at the wellbore, a high-thermal conductivity compacted sheath comprising multiple sheath segments along a vertical length of the high-thermal conductivity compacted sheath that is thermally coupled to (a) an outer surface of the casing and substantially vertically extends along some of the length of the target location in the annular space of the wellbore, and (b) the mouth portion of the TRE structure to thereby form a continuous heat transfer path from the target location via the TRE structure and compacted sheath to the casing.

Most typically, the target location is at a depth of between 150 m and 20,000 m, wherein the geological formation at the target location has a geostatic temperature of between 120° C. and 600° C.

In addition, it is generally contemplated that the TRE structure comprises a plurality of particles comprising a material selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, cobalt, copper alloys, nickel, iron, platinum, palladium, tin, steel, zirconium, titanium, carbon fiber, carbon black, and Hastelloy, and optionally that the TRE structure comprises at least two chemically distinct particles selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, cobalt, copper alloys, nickel, iron, platinum, palladium, tin, steel, zirconium, titanium, carbon fiber, carbon black, and Hastelloy. Preferably, but not necessarily, the TRE structure has a width that decreases from the proximal mouth portion to the distal portion. In some embodiments, the TRE structure extends longitudinally along the wellbore, wherein the TRE structure has a width of between 1 mm and 10 mm and extends into the formation a longitudinal distance of between 1 m and 200 m. Moreover, the TRE structure may also have a bi-wing configuration.

Furthermore, it is contemplated that the TRE structure has a thermal conductivity of between 1.5 and 150 W/mK, and that a first high thermal k material of the proximal mouth portion is flush to the annular space of the wellbore. Moreover, the contemplated system may further include a second TRE structure that has a vertical offset from the TRE structure of between 10 m and 100 m, with a radial offset from the TRE structure of between 15 degrees and 90 degrees. Typically, the first high thermal k material of the proximal mouth portion of the second TRE structure is also flush to the annular space of the wellbore.

In some embodiments, the second TRE structure comprises at least two chemically distinct particles comprising a material selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, cobalt, copper alloys, nickel, iron, platinum, palladium, tin, steel, zirconium, titanium, carbon fiber, carbon black, and Hastelloy.

In terms of the compacted sheath, it is generally contemplated that the compacted sheath has a thermal conductivity of between about 1.5 W/mK and 50 W/mK, or between about 30 W/mK and 400 W/mK. In some embodiments, the compacted sheath comprises two different types of thermally conductive particles. Most typically, each sheath segment of the compacted sheath has a height of between 3 m and 500 m. Preferably, the compacted sheath extends substantially vertically along between 10% and 70% of the target location.

In additional embodiments, the compacted sheath has a thermal conductivity that is equal or differs no more than 50% of the thermal conductivity of the TRE structure. In other embodiments, the compacted sheath has a thermal conductivity that is equal or differs no more than 30% of the thermal conductivity of the TRE structure. Yet in some embodiments, the compacted sheath has a thermal conductivity that is equal or differs no more than 10% of the thermal conductivity of the TRE structure or are the same.

Viewed from yet another perspective, the inventors contemplate a system configured to transfer heat from a geological formation to a heat harvester casing that comprises a heat harvester casing disposed in a wellbore that descends substantially vertically from a topside location to a target location in a geological formation. The system is contemplated to further include a high-thermal conductivity compacted sheath comprising multiple sheath segments along a vertical length of the high-thermal conductivity compacted sheath, that is thermally coupled to (a) an outer surface of the casing and substantially vertically extends along some of the length of the target location in an annular space of the wellbore, and (b) the target location in the geological formation to thereby form a continuous heat transfer path from the target location via the high-thermal conductivity compacted sheath to the casing.

Most typically, the target location is at a depth of between 150 m and 20,000 m, with the geological formation at the target location having a geostatic temperature of between 120° C. and 600° C.

It is generally contemplated that the compacted sheath has a thermal conductivity of between about 1.5 W/mK and 50 W/mK, or between about 30 W/mK and 400 W/mK. In some embodiments, each sheath segment of the compacted sheath has a height of between 5 m and 500 m. Preferably, the compacted sheath extends substantially vertically along between 10% and 70% of the target location.

Where desired, the compacted sheath may comprise two different types of thermally conductive particles.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 depicts photographs showing changes in porosity that occur depending on the method of consolidation used.

FIG. 2 is an exemplary schematic illustrating the two steps required to achieve compaction, that is, settling and consolidation.

FIG. 3 is a graph depicting the heat produced per kilometer of wellbore depending on the varying values of the thermal conductivity of a settled particle sheath placed without a TRE structure in the formation.

### DETAILED DESCRIPTION

The inventors have discovered various compositions and systems of providing a high-thermal conductivity (k) sheath that is derived from a pumpable suspension comprising a high apparent viscosity carrier fluid and a plurality of high thermal conductivity particles. Most typically, the high apparent viscosity carrier fluid is thinned or broken such that the viscosity is reduced to allow settling of the TRE particles that were previously suspended. In some embodiments, the particles settle in an annular space such that a mass is formed, and upon consolidation, results in a compacted sheath that thermally couples the heat harvesting casing to the geological resource. Preferably, but not necessarily, the compacted sheath has a thermal conductivity of at least 1.5 W/mK, or at least 5 W/mK, or at least 10 W/mK, or at least 25 W/mK, or at least 50 W/mK, or at least 100 W/mK, or at least 200 W/mK, or at least 300 W/mK, or at least 400 W/mK.

Conventionally, geothermal wells contain significant amounts of curable materials (e.g., cementitious materials) for hardening of the grout mixture. However, curable materials do not exhibit desirable high-thermal conductivity. Alternatively, particulate mixtures that are free of curable materials have been utilized in certain subsurface applications, such as plugging underground pipes (see e.g., U.S. Pat. Nos. 6,715,543 and 7,258,174). While these particulate mixtures are free of curable materials, these particulate mixtures lack high-thermal conductivity and are typically not suitable for installation at the extreme temperatures (e.g., 300° C.) near a target location (e.g., geothermal energy source).

On the other hand, certain high-thermal conductivity fluid mixtures have also been disclosed. For example, in WO 2014/092940, methods and compositions are presented for introducing a shear-thinning, pumpable, and settable fluid into a well through a drill string or bottom hole assembly. While interesting, the reference focuses on treating an oil or gas production well (i.e., changing a condition of a portion of a wellbore or a subterranean formation adjacent a wellbore) and reducing the amount of drilling fluid that is lost to the geological formation rather than improving thermal conductivity.

Likewise, U.S. Pat. App. No. 2011/0232858 teaches systems and methods in which heat for power production is extracted from a geologic formation having high temperatures (e.g., 500° C.) in which one or more bore holes contain a thermally conductive compacted filler that conducts heat to a piping system at a target location. Here, the compacted filler is graphite formulated as a powder or as a rod. To reduce the incidence of void spaces that can act as an insulator, the '858 application relies on high pressure compaction. Therefore, while multiple and/or extensive carbon-filled conduits in the formation can be formed, heat transfer to the working fluid of a tube-in-tube system is typically limited to the terminal portion of the system (as the compaction pressure would otherwise crush the tube-in-tube system), thereby significantly reducing overall heat harvest. Heat harvest can be increased with multiple graphite filled channels that converge at the tube-in-tube system, but such an increase also increases operational complexity and cost.

Furthermore, in WO 2023/150450, a slurry mixture comprises a high-thermal k material in the form of a plurality of particles with a wide size distribution that enable compaction of the particles under geostatic pressure in a fracture at a target location to form a TRE structure with high thermal conductivity that can even remain moveable in the presence of substantial forces (e.g., earthquakes). Although mechanistically intriguing, the compaction contemplated relies on the presence of geostatic pressure, which significantly limits tight settling of the particles within the slurry in instances where geostatic pressure is reduced or lacking.

Thus, even though various compositions and methods for geothermal heat transfer compositions are known in the art, all or almost all of them suffer from several drawbacks. Therefore, there remains a need for high-thermal conductivity compositions and systems that are pumpable and can thermally couple the geological formation to a casing within a wellbore at high thermal conductivity for purposes of improved electrical or thermal energy generation.

In view of the above, it should therefore be appreciated that the compositions and systems presented herein provide significant advancements in the field of thermal energy transfer in geothermic plants. The energy produced by the geothermal systems contemplated herein may be used for heating or cooling (direct use applications) or may convert harvested heat to electricity through use of a surface power plant for thermal-to-electric energy conversion. Moreover, geothermal systems may be integrated with equipment that consumes energy, e.g., a geothermal plant for hydrogen or other renewable fuel production, carbon capture, or desalination. The geothermal well may circulate working fluid and thereby continuously produce energy at a constant rate, or the flow rate of the working fluid may be controlled such that the well produces a time-variable amount of energy.

Most significantly, the compositions and systems presented herein are all for substantially simplified deployment of the thermally conductive materials to a target zone as the material is delivered as a pumpable suspension without issues otherwise encountered with curable (typically cementitious) compositions. Indeed, the placement and even composition of the suspension can be modified/adjusted, even during deployment, and will not inadvertently or prematurely cure to a hardened state. Moreover, the pumpable suspension (by virtue of viscosity breaking and subsequent settling of thermally conductive particles) can be converted at will to a composition in which the rate and speed of settling of the thermally conductive particles can be readily controlled, thereby allowing operational control that has not been achieved with other compositions. Still further, thermal conductivity can be additionally increased by consolidation of the settled particles, thus enabling formation of a highly thermally conductive compacted structure (typically a sheath around a heat harvesting casing). Lastly, due to the control over viscosity, pumping operations can even be aborted and reversed in instances where unforeseen difficulties in placement or well conditions arise.

As will be readily appreciated, the contemplated pumpable suspension may comprise a mixture of a suspended thermal reach enhancement (TRE) solid and a high apparent viscosity carrier fluid. In some embodiments, the TRE solid is typically in the form of a plurality of TRE particles and the high apparent viscosity carrier fluid suspends the particles throughout the fluid. As briefly discussed above, the high apparent viscosity carrier fluid may have properties that permit operational control over settling of the plurality of TRE particles. Preferably, the high apparent viscosity carrier fluid has a composition that allows an additive or triggering event to change physical and/or chemical properties of the mixture in situ to thereby reduce viscosity and thereby allow the particles to settle via gravity at a target location to so form a settled particle sheath within an annular space of a geothermal wellbore at a target location. Consequently, it is contemplated that the TRE particles have a composition that allows consolidation of the settled particle sheath to form a high-thermal conductivity compacted sheath within the annular space of the wellbore.

As used herein, the term “settled” involves the downward movement of the TRE particles under gravity. Where the TRE particles are generally moving from a previously suspended state in the high apparent viscosity carrier fluid to a settled mass state at the bottom of an annular space in a wellbore. As also used herein, the term “consolidated” involves the compaction of porous material upon a reduction of its pore pressure. Preferably, the porous material comprises the plurality of TRE particles. In some embodiments, consolidation may be hydraulic (where pore pressure decreases due to fluid flow according to Darcy) or consolidation may be chemical (where pore pressure decreases due to fluid consumption by chemical reactions). The consolidation process is typically initiated after the plurality of TRE particles are no longer suspended in the high apparent viscosity carrier fluid and after a sufficient settling time. Lastly, as additionally used herein, the term “compacted” describes the target final state of the high thermal conductivity compacted sheath. This stage is achieved after the plurality of TRE particles undergo both the settling and consolidation processes, reaching a final desired state of porosity and thermal conductivity condition.

Consequently, a system is contemplated herein that is configured to transfer heat from a geological formation to a heat harvester casing. Most typically, the heat harvester casing may be disposed in a wellbore that descends substantially vertically from a topside location to a target location in a geological formation. In some embodiments, a thermal reach enhancement (TRE) structure at the target location comprises a first high thermal k material, wherein the TRE structure extends from the wellbore distally into the geological formation at the target location, and wherein the TRE structure has a mouth portion at the wellbore. Preferably, a high-thermal conductivity compacted sheath comprising multiple sheath segments along a vertical length of the high-thermal conductivity compacted sheath is thermally coupled to (a) an outer surface of the casing and substantially vertically extends along some of the length of the target location in an annular space of the wellbore, and (b) the mouth portion of the TRE structure to thereby form a continuous heat transfer path from the target location via the TRE structure and compacted sheath to the casing.

Additionally, another system is contemplated that is configured to transfer heat from a geological formation to a heat harvester casing without the implementation of TRE structures. In such an embodiment, a heat harvester casing is again disposed in a wellbore that descends substantially vertically from a topside location to a target location in a geological formation. A high-thermal conductivity compacted sheath, comprising multiple sheath segments along a vertical length of a the high-thermal conductivity compacted sheath, is thermally coupled to (a) an outer surface of the casing and substantially vertically extends along some of the length of the target location in an annular space of the wellbore, and (b) the target location in the geological formation to thereby form a continuous heat transfer path from the target location via the high-thermal conductivity compacted sheath to the casing.

Regardless of the system, the target location typically has a target temperature of at least 120° C., at least 180° C., at least 250° C., at least 300° C., at least 350° C., at least 400° C., at least 450° C., or at least 500° C., or at least 600° C. and/or the target location may be below ground at a depth of at least 150 m, at least 300 m, at least 500 m, at least 600 m, at least 700 m, at least 800 m, at least 900 m, at least 1,000 m, at least 1,250 m, at least 1,500 m, at least 1,750 m, at least 2,000 m, at least 2,500 m, at least 3,000 m, at least 4,000 m, at least 5,000 m, at least 10,000 m, or at least 20,000 m.

In certain embodiments, the target location extends in a substantially vertical orientation. The term “substantially” as utilized herein means that the target location extends toward the center of the earth but may be offset from the center by no greater than 15 degrees, no greater than 10 degrees, no greater than 5 degrees, or no greater than 1 degree. It is to be appreciated that the geothermal wellbore may have multiple target locations and thus may have both substantially vertical orientated target locations and target locations extending in orientations that are at least 30 degrees.

The target location, typically being a hot dry rock (e.g., intrusive igneous or metamorphous rock, granitic, basaltic, sedimentary), may or may not include a plurality of fissures that longitudinally extend from the wellbore into the formation. In other embodiments, the target location may also comprise permeable or impermeable rock. Additionally, it is contemplated that the geothermal system may be located in hot wet rock, a “greenfield”, a “brownfield”, the ocean floor, and/or an oil/gas well. In terms of using oil/gas wells, geothermal energy may be harnessed through the retrofitting of inactive or unproductive wells and co-production on active wells. For example, an old well may be cleaned out then installed with contemplated systems herein. In a further example, an old well may be cleaned out, then deepened prior to installation of systems contemplated herein. Alternatively, an old well may be cleaned out, sidetracked, drilled, and then have the contemplated systems installed. In terms of drilling on the ocean floor, it is contemplated that a geothermal system could be placed at or near seafloor spreading rifts. Drilling on the ocean floor may also be anywhere else where geothermal energy can be extracted, such as major tectonic plate boundaries or rift zones.

Regardless of the target location, in various embodiments, the wellbore may include man-made and/or naturally occurring fissures, and such fissures may longitudinally extend from the wellbore over a distance of at least 3 m, at least 4 m, at least 5 m, at least 6 m, at least 7 m, at least 8 m, at least 9 m, or at least 10 m, and even more. The fissures can be at least partially filled with a compacted high-thermal k material or thermal reach enhancement (TRE) particles to so form TRE structures. In some embodiments, at least 10%, at least 20%, at least 30%, at least 40%, at least 50%, at least 60%, at least 70%, at least 80%, or at least 90%, and even more, of the volume of each of the fissures contains the compacted high-thermal k material.

The fissures are contemplated to be adjacent to the wellbore and at least partially filled with a high-thermal conductivity material to thereby form a plurality of thermal reach enhancement (TRE) structures. When TRE structures are implemented, the high-thermal conductivity material in the TRE structures is contemplated to be thermally coupled with the settled or compacted sheath in the wellbore. Most typically, a first high thermal k material of the proximal mouth portion of the first and/or second TRE structure is flush to the annular space of the wellbore and/or the resulting compacted sheath within the annular space of the wellbore to thereby allow continuous heat transfer from the geological formation, through the high thermal conductivity compacted sheath and heat harvester casing, to the wellbore and the working fluid.

In further contemplated aspects, TRE structures may have a width between 1 mm and 10 mm, between 5 mm and 30 mm, or between 10 and 50 mm, or between 25 and 80 mm, or between 1 mm and 100 mm. In some embodiments, the TRE structures may extend into the formation a longitudinal distance of at least 1 m, at least 50 m, at least 100 m, at least 150 m, or at least 200 m. Still further, and regardless of the specific configuration, it is contemplated that the fissures, and subsequent TRE structures placed within the fissures, in the target location may not only be a single linear break in the rock formation but may also form a complex structure (such as a reticular or dendritic structure). Advantageously, such complex structure will provide for an even larger thermal exchange surface with the remainder of the unfractured rock in the target location. For example, the TRE structures may be formed to have a longitudinal complex multi-fractured geometry with a width of between 10 mm and 50 mm and a length of at least 10 m as measured from the wellbore. However, despite a given width and length of a fissure, the effective length is the amount of the fissure that may be used for the TRE structure. For example, a fissure may be 200 m in total length but only 10 m is the effective length for the TRE structure. Nonetheless, regardless of the specific dimensions it is generally preferable that the TRE structure has a width that decreases from the proximal mouth portion to the distal portion, where the TRE structure extends longitudinally along the wellbore.

As previously mentioned, in this context it should be noted that the compacted high-thermal k material of the TRE structure will typically terminate on a proximal end at the target location of the wellbore such that the compacted high-thermal k material is in uninterrupted (continuous) thermal exchange with a high-thermal conductivity sheath in the wellbore. Thus, the high-thermal k material of the proximal mouth portion of the TRE structure is typically (but not necessarily) flush to the wellbore and/or any annular space within the wellbore. Consequently, a continuous heat transfer path is formed from the target location in the geological formation, via the TRE structure and high-thermal conductivity sheath, to the casing and subsequently to the working fluid within the casing. Furthermore, in at least some embodiments the TRE structure will have a wedge-shaped configuration. Therefore, it should be appreciated that the compacted high-thermal k material of the fissures provides additional thermally conductive surfaces to improve heat extraction from target areas within the formation as opposed to only surfaces of the formation immediately adjacent to the wellbore. Viewed from a different perspective, the compacted high-thermal k material in the fissures will act as a radiator fin or wing that acts as a heat exchange surface to provide significantly improved heat transfer on a per unit length basis of the wellbore, which in turn increases revenue generation for power producing wells. The high thermal k material of the TRE structure will have a thermal conductivity of at least 1.5 W/mK, at least 5 W/mK, or at least 10 W/mK, or at least 25 W/mK, or at least 50 W/mK, or at least 100 W/mK, or at least 250 W/mK, or at least 500 W/mK.

In some embodiments, the fissures will result in TRE structures with a bi-wing configuration comprising a first TRE structure and/or an opposite second TRE structure. It is also contemplated that TRE structures may be in tri-wing configurations or quad-wing configurations. In addition, a secondary, or a tertiary, or a quaternary TRE structure will have a vertical offset from the first TRE structure of at least 5 m, or at least 10 m, or at least 20 m, or at least 40 m, or at least 60 m, or at least 100 m. A secondary, or a tertiary, or a quaternary TRE structure will also most likely have a radial offset, from the first TRE structure of at least 10 degrees, or at least 20 degrees, or at least 40 degrees, or at least 90 degrees.

It is generally contemplated that the TRE structure comprises a plurality of particles selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, zinc, cobalt, copper alloys, nickel, iron, platinum, palladium, tin, steel, zirconium, titanium, carbon fiber, carbon black, and Hastelloy. Where desired, the TRE structure may comprise at least two chemically distinct particles selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, zinc, cobalt, copper alloys, nickel, iron, platinum, palladium, tin, steel, zirconium, titanium, carbon fiber, carbon black, and Hastelloy. Likewise, the second TRE structure may also comprise at least two chemically distinct particles selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, zinc, cobalt, copper alloys, nickel, iron, platinum, palladium, tin, steel, zirconium, titanium, carbon fiber, carbon black, and Hastelloy.

Regardless of the system used to transfer heat from the geological formation to the heat harvester casing in the wellbore, that is, regardless of whether or not there are TRE structures implemented, the aforementioned high-thermal conductivity compacted sheath may be formed from the pumpable suspension contemplated herein. As briefly discussed above, a pumpable suspension comprising a mix of a plurality of suspended TRE particles and a high apparent viscosity carrier fluid may be settled and consolidated in an annular space of a wellbore to subsequently form the high-thermal conductivity compacted sheath.

Most typically, the high apparent viscosity carrier fluid of the pumpable suspension has a composition that allows an additive or triggering event to change physical and/or chemical properties of the mixture in situ (i.e., a change in chemical reactivity, pH, temperature, or time), to thereby reduce apparent viscosity and thereby allow the TRE particles to settle via gravity at the target location to so form a settled particle sheath with a thermal conductivity of at least 1.5 W/mK, or at least 3 W/mK, or at least 5 W/mK, or at least 10 W/mK, or at least 20 W/mK, or at least 50 W/mK, or at least 100 W/mK, or at least 200 W/mK, or at least 400 W/mK.

The high apparent viscosity carrier fluid most typically comprises a quantity of water (e.g., water only or an aqueous solvent system). However, in some embodiments, the high apparent viscosity carrier fluid most typically comprises a water-soluble biopolymer, a water-soluble derivatized biopolymer, a water-soluble gum, a water-soluble cellulose, a water-soluble synthetic polymer, or a surfactant, and optionally, wherein the gum, cellulose, polymer, or biopolymer-surfactant in the carrier fluid forms a network, is crosslinked, or forms a supramolecular structure. Preferably, the gum, cellulose, polymer, or biopolymer bonds to the TRE particles and forms a suspended particle, a particle filled network, a crosslinked particle filled polymer network, or forms a particle filled supramolecular structure.

In this context, it is contemplated that a high apparent viscosity will typically have a dynamic viscosity at a temperature of 20° C. and before viscosity breaking or a trigger event of between 500 cP and 10,000 cP (e.g., between 500 and 1,500, or between 1,500 and 3,000, or between 3,000 and 6,000, or between 6,000 and 10,000 cP), and in some cases even higher (e.g., between 10,000 and 25,000 cP). It is generally contemplated that dynamic viscosity may be measured according to the standard test method provided by the American Society for Testing and materials (ASTM) D7042 using a Stabinger Viscometer. Additionally, or alternatively, viscosity may also be determined by standards set forth by the International Standards Organization (ISO). However, it is also contemplated that conventional standards and methods may be utilized, such as rotational viscometers, capillary viscometers, falling sphere viscometer, flow cups, or other tools typically used in the art. Regardless, it is in this state that the high apparent viscosity carrier fluid is combined with the thermally conductive particles to so form a pumpable mixture for deployment to the target area in the geothermic well. As will be readily appreciated, the magnitude of the drop in apparent viscosity due to the chemical reaction or triggering event (visbreaking) will depend at least in part on the specific materials and conditions used. However, it is generally contemplated that the dynamic viscosity of the carrier fluid will be at least one order of magnitude lower, or at least two orders of magnitude lower. Thus, suitable dynamic viscosities after the chemical reaction or triggering event will typically be between 5 and 1,000 cP (e.g., between 5 and 15, or between 15 and 100, or between 100 and 500, or between 500 and 1,000 cP), and in some cases even higher.

As used herein, “breaking” refers to a process in which the viscosity of a high viscosity fluid is reduced to allow for faster settling of thermally conductive materials that are suspended in the high apparent viscosity fluid. As mentioned above and throughout, viscosity may be reduced, and a high viscosity fluid thereby broken, by a triggering event such as a change in chemical composition, pH, temperature, and/or by the passage of time,

Nonetheless, suitable additives for the high apparent viscosity carrier fluid include an oxidizer, a biobased enzyme, a bacterium, or a pH modifier, that allows reducing the viscosity with a shear force or temperature change. Most typically the additive comprises at least 0.001 wt %, or at least 0.001 wt %, or at least 0.01 wt %, or at least 0.1 wt %, or at least 1 wt %, or at least 5 wt %, or at least 10 wt % of the total suspension wt %. In some embodiments, the additive modifies the temperature stability of the pumpable suspension. In other embodiments, an additive may be used that absorbs thermal energy. Nonetheless, the pumpable suspension optionally further comprises a second additive that promotes the association of the plurality of TRE particles to a viscosity agent to thereby improve mixing and dispersion of the plurality of TRE particles within the high apparent viscosity carrier fluid. It is further contemplated that the high apparent viscosity carrier fluid may include a second additive that breaks a polymer backbone or a polymer-polymer crosslink, optionally in response to the triggering event. Where desired, the pumpable suspension may also optionally further comprise a second additive that absorbs thermal energy to extend the usable temperature range for a given polymer by at least 1° C., or at least 5° C., or at least 10° C., or at least 20° C., or at least 35° C., or at least 50° C.

Furthermore, additives are most typically selected from a cross-linker additive, a dispersant additive, a breaker additive, a de-airing additive, or a stabilizer additive. For example, the cross-linker additive may be aluminum, chromium, metal antimony, boron, titanium, or zirconium based. The dispersant additive may be a surfactant, a polymer, a salt, or a pH modifier. The de-airing additive may be present to prevent, destroy, or release trapped air bubbles such that the steps of settling and consolidation are optimized. Suitable de-airing additives include a polydimethylsiloxane, and alcohol, a stearate, a glycol, a surfactant, an alkylphenol ethoxylate, a silicone defoamer, a mineral oil defoamer, a vegetable oil defoamer, a wax-based defoamer, a polymer defoamer, or a silicone-free defoamer. The breaker additive may be a pH modifier, an oxidizer, an enzyme, or a bacterium. Preferably, the stabilizer additive is an oxidizer or a gel. Nonetheless, the high apparent viscosity carrier fluid typically comprises at least two distinct additives.

As will be readily appreciated, the high apparent viscosity carrier fluid typically further includes a viscosity agent that is used to modify the rheological properties of the high apparent viscosity carrier fluid in response to a variety of stimuli, such as temperature, pressure, contact with another material, or combinations thereof, or improve mixability of the pumpable suspension. Suitable viscosity agents include a guar gum, a polysaccharide (starch, guar, cellulose, cellulose derivatives, alginates, carrageenan, or locust gum), xanthan, hydroxylethyl cellulose (HEC), a carboxymethyl guar (CMG), carboxymethyl hydroxylethyl cellulose (CMHEC) a hyperbranched polyglycerol (HPG), a carboxymethyl hydroxypropyl guar (CMHPG), a carboxymethyl cellulose (CMC), a high strength molding compound (HMC), an acrylamide, a poly (acrylamide/acrylic acid/2-acrylamido-2-methylpropane sulfonic acid) (AMPS-AA-AM), and/or a viscoelastic surfactant (VES). The viscosity agent may also be selected from the group consisting of a plasticizer, a surfactant, an organic polymer, a silica filler, a NaCl, KCl or other inorganic salt, a clay, a modified coal, and/or combinations thereof.

The plasticizer may be present in the suspension to improve workability for ease of placement. In various embodiments, the term “plasticizer” refers to a material that increases the fluidity. Suitable plasticizers may include, but are not limited to, polycarboxylic ether plasticizers, phthalate plasticizers, terephthalate plasticizers, sulfonamide plasticizers, benzoate plasticizers, phosphate plasticizers, or combinations thereof.

In some embodiments, the plasticizer may be present in the pumpable suspension in an amount sufficient to provide the desired amount of workability to the pumpable suspension. The plasticizer may be present in the pumpable suspension in an amount of at least 1 wt. %, 2 wt. %, 3 wt. %, 4 wt. %, 5 wt. %, 6 wt. %, 7 wt. %, 8 wt. %, 9 wt. %, or 10 wt. %, based on a total weight of the pumpable suspension. Alternatively, the plasticizer may be present in the pumpable suspension in an amount of no greater than 20 wt. %, 19 wt. %, 18 wt. %, 17 wt. %, 16 wt. %, 15 wt. %, 14 wt. %, 13 wt. %, 12 wt. %, 11 wt. %, or 10 wt. %, based on a total weight of the pumpable suspension. Alternatively, the plasticizer may be present in the pumpable suspension in an amount of from about 1 to about 20 wt. %, from about 5 wt. % to about 15 wt. %, or from about 7 wt. % to about 13 wt. %, based on a total weight of the pumpable suspension.

The surfactant may be present in the pumpable suspension to improve surface properties of the pumpable suspension. Suitable surfactants may include, but are not limited to, a non-ionic surfactant, an anionic surfactant, a cationic surfactant, a zwitterionic surfactant, or combinations thereof.

Suitable non-ionic surfactants may include, but are not limited to, an alkyoxylate (e.g., an alkoxylated nonylphenol condensate, such as poly(oxy-1,2-ethanediyl), alpha-(4-nonylphenyl)-omega-hydroxy-branched), an alkylphenol, an ethoxylated alkyl amine, an ethoxylated oleate, a tall oil, an ethoxylated fatty acid, an alkyl polyglycoside, a sorbitan ester, a methyl glucoside ester, an amine ethoxylate, a diamine ethoxylate, a polyglycerol ester, an alkyl ethoxylate, an alcohol that has been polypropoxylated and/or polyethoxylated, a linear alcohol alkoxylate, dodecylbenzene sulfonic acid salt derivative, a linear nonyl-phenol, dioxane, ethylene oxide, polyethylene glycol, an ethoxylated castor oil, polyoxyethylene nonyl phenyl ether, tetraethyleneglycoldodecylether, ethylene oxide, decylamine oxide, dodecylamine oxide, an alkylamine oxide, an ethoxylated amide, an alkoxylated fatty acid, an alkoxylated alcohol (e.g., lauryl alcohol ethoxylate, ethoxylated nonyl phenol), an ethoxylated fatty amine, an ethoxylated alkyl amine (e.g., cocoalkylamine ethoxylate), any derivative thereof, and any combination thereof. As used herein, the term “derivative,” refers to any compound that is made from one of the identified compounds, for example, by replacing one atom in the listed compound with another atom or group of atoms or rearranging two or more atoms in the listed compound.

Suitable anionic surfactants may include, but are not limited to, methyl ester sulfonate, a hydrolyzed keratin, polyoxyethylene sorbitan monopalmitate, polyoxyethylene sorbitan monostearate, polyoxyethylene sorbitan monooleate, an alkyl ether sulfate, sodium 4-(1′heptylnonyl)benzenesulfonate, sodium dioctyl sulphosuccinate, sodium octlylbenzenesulfonate, sodium hexadecyl sulfate, sodium laureth sulfate, a quaternary ammonium compound (e.g., a trimethylcocoammonium chloride, a trimethyltallowammonium chloride, a dimethyldicocoammonium chloride, and the like), a cetylpyridinium chloride, an alkyl ester sulfonate, an alkyl ether sulfonate, an alkyl ether sulfate, an alkali metal alkyl sulfate, an alkyl sulfonate, an alkylaryl sulfonate, a sulfosuccinate, an alkyl disulfonate, an alkylaryl disulfonate, an alkyl disulfate, an alcohol polypropoxylated sulfate, an alcohol polyethoxylated sulfateany derivative thereof, or any combination thereof.

Suitable zwitterionic surfactants may include, but are not limited to, an alkyl amine oxide, an alkyl betaine, an alkyl arnidopropyl betaine, an alkyl sulfobetaine, an alkyl sultaine, a dihydroxyl alkyl glycinate, an alkyl ampho acetate, a phospholipid, an alkyl aminopropionic acid, an alkyl imino monopropionic acid, an alkyl imino dipropionic acid, dipalmitoyl-phosphatidylcholine, an amine oxide, a betaine, a modified betaine, an alkylamidobetaine (e.g., cocoamidopropyl betaine), and any combination thereof.

In further example, surfactants that may exhibit viscoelastic properties may include, but are not limited to, a sulfosuccinate, a taurate, an amine oxide (e.g., an amidoamine oxide), an ethoxylated amide, an alkoxylated fatty acid, an alkoxylated alcohol, an ethoxylated fatty amine, an ethoxylated alkyl amine, a betaine, modified betaine, an alkylamidobetaine, a quaternary ammonium compound, an alkyl sulfate, an alkyl ether sulfate, an alkyl sulfonate, an ethoxylated ester, an ethoxylated glycoside ester, an alcohol ether, any derivative thereof, and any combination thereof.

In some embodiments, the surfactant may be present in the pumpable suspension in an amount sufficient to provide the desired amount of surface properties to the pumpable suspension. The surfactant may be present in the pumpable suspension in an amount of at least 1 wt. %, 2 wt. %, 3 wt. %, 4 wt. %, 5 wt. %, 6 wt. %, 7 wt. %, 8 wt. %, 9 wt. %, or 10 wt. %, based on a total weight of the pumpable suspension. Alternatively, the surfactant may be present in the pumpable suspension in an amount of no greater than 20 wt. %, 19 wt. %, 18 wt. %, 17 wt. %, 16 wt. %, 15 wt. %, 14 wt. %, 13 wt. %, 12 wt. %, 11 wt. %, or 10 wt. %, based on a total weight of the pumpable suspension. Alternatively, the surfactant may be present in the pumpable suspension in an amount of from about 1 to about 20 wt. %, from about 5 wt. % to about 15 wt. %, or from about 7 wt. % to about 13 wt. %, based on a total weight of the pumpable suspension.

The organic polymer may be present in the pumpable suspension to improve properties of the pumpable suspension. Suitable organic polymers may include, but are not limited to, natural compounds, synthetic compounds, or a combination thereof. Non-limiting examples of suitable natural compounds include polysaccharides, such as polysaccharides and polysaccharide ethers which are soluble in cold water, such as cellulose ethers, starch ethers (amylose and/or amylopectin and/or derivatives thereof), guar ethers dextrins, or combinations thereof. Non-limiting examples of suitable synthetic compounds include protective colloids, for example one or more polyvinylpyrrolidones and/or polyvinylacetals, polyvinyl alcohols, melamine formaldehyde sulfonates, naphthalene formaldehyde sulfonates, block copolymers of propylene oxide and ethylene oxide, styrene-maleic acid and/or vinyl ether-maleic acid copolymers.

In some embodiments, the organic polymer may be present in the pumpable suspension pumpable suspension in an amount sufficient to provide the desired properties to the pumpable suspension. The organic polymer may be present in the pumpable suspension in an amount of at least 1 wt. %, 2 wt. %, 3 wt. %, 4 wt. %, 5 wt. %, 6 wt. %, 7 wt. %, 8 wt. %, 9 wt. %, or 10 wt. %, based on a total weight of the pumpable suspension. Alternatively, the organic polymer may be present in the pumpable suspension in an amount of no greater than 20 wt. %, 19 wt. %, 18 wt. %, 17 wt. %, 16 wt. %, 15 wt. %, 14 wt. %, 13 wt. %, 12 wt. %, 11 wt. %, or 10 wt. %, based on a total weight of the pumpable suspension. Alternatively, the organic polymer may be present in the pumpable suspension in an amount of from about 1 to about 20 wt. %, from about 5 wt. % to about 15 wt. %, or from about 7 wt. % to about 13 wt. %, based on a total weight of the pumpable suspension.

Where desired, a silica filler may be present in the pumpable suspension to improve properties of the pumpable suspension. Suitable silica filler may be a pyrogenic or precipitated finely divided silica. The silica filler may have a particle size of from about 50 to 10,000 angstroms, from about 50 to about 400, or from about 100 to about 300 angstroms. The silica filler may be present in the pumpable suspension in an amount of at least 1 wt. %, 2 wt. %, 3 wt. %, 4 wt. %, 5 wt. %, 6 wt. %, 7 wt. %, 8 wt. %, 9 wt. %, or 10 wt. %, based on a total weight of the pumpable suspension. Alternatively, the silica filler may be present in the pumpable suspension in an amount of no greater than 20 wt. %, 19 wt. %, 18 wt. %, 17 wt. %, 16 wt. %, 15 wt. %, 14 wt. %, 13 wt. %, 12 wt. %, 11 wt. %, or 10 wt. %, based on a total weight of the pumpable suspension. Alternatively, the silica filler may be present in the pumpable suspension in an amount of from about 1 to about 20 wt. %, from about 5 wt. % to about 15 wt. %, or from about 7 wt. % to about 13 wt. %, based on a total weight of the pumpable suspension.

The inorganic salt may be present in the pumpable suspension to improve mixability of the pumpable suspension. Suitable inorganic salts may include, but are not limited to, NaCl, KCl, and the like. The inorganic salt may be present in the pumpable suspension in an amount of at least 1 wt. %, 2 wt. %, 3 wt. %, 4 wt. %, 5 wt. %, 6 wt. %, 7 wt. %, 8 wt. %, 9 wt. %, or 10 wt. %, based on a total weight of the pumpable suspension. Alternatively, the inorganic salt may be present in the pumpable suspension in an amount of no greater than 20 wt. %, 19 wt. %, 18 wt. %, 17 wt. %, 16 wt. %, 15 wt. %, 14 wt. %, 13 wt. %, 12 wt. %, 11 wt. %, or 10 wt. %, based on a total weight of the pumpable suspension. Alternatively, the inorganic salt may be present in the pumpable suspension in an amount of from about 1 to about 20 wt. %, from about 5 wt. % to about 15 wt. %, or from about 7 wt. % to about 13 wt. %, based on a total weight of the pumpable suspension.

The clay may be present in the pumpable suspension to modify flowability of the pumpable suspension. Suitable clay may include a member of the smectite family, a member of the palygorskite-sepiolite phyllosilicate family, a member of the kaolinite-serpentine family, nontronite, bentonite, hectorite, attapulaite, fluoromica, montmorillonite, beidellite, saponite, sepiolite, kaolinite, illite, any cation exchanged version thereof, or combinations thereof.

Of the suitable smectite family clays including nontronite, montmorillonite, saponite, hectorite, and beidellite, other suitable smectite family clays for use as the aqueous swellable clays of the present disclosure may include, but are not limited to, aliettite, ferrosaponite, sauconite, stevensite, swinefordite, volkonskoite, yakhontovite, and any combination thereof. Suitable members of the palygorskite-sepiolite pyhyllosilicate family may include, but are not limited to, attapulgite, tuperssautsiaite, windhoekite, yofortierite, falcondoite, ferrisepiolite, loughlinite, and any combination thereof. Suitable members of the kaolinite-serpentine family of aqueous swellable clays may include, but are not limited to, kaolinite, greenalite, fraipontite, halloysite, dickite, lizardite, manandonite, nacrite, cronstedtite, clinochrysotile, chrysotile, nepouite, odinite, webskyite, pecoraite, orthochrysotile, parachrysotile, caryopilite, brindleyite, berthierine, amesite, antigorite, baumite, and any combination thereof.

In some embodiments, the clay may be present in the pumpable suspension in an amount sufficient to provide the desired properties to the pumpable suspension. The clay may be present in the pumpable suspension in an amount of at least 1 wt. %, 2 wt. %, 3 wt. %, 4 wt. %, 5 wt. %, 6 wt. %, 7 wt. %, 8 wt. %, 9 wt. %, or 10 wt. %, based on a total weight of the pumpable suspension. Alternatively, the clay may be present in the pumpable suspension in an amount of no greater than 20 wt. %, 19 wt. %, 18 wt. %, 17 wt. %, 16 wt. %, 15 wt. %, 14 wt. %, 13 wt. %, 12 wt. %, 11 wt. %, or 10 wt. %, based on a total weight of the pumpable suspension. Alternatively, the clay may be present in the pumpable suspension in an amount of from about 1 to about 20 wt. %, from about 5 wt. % to about 15 wt. %, or from about 7 wt. % to about 13 wt. %, based on a total weight of the pumpable suspension.

Where coal or other carbonaceous particles are included, it is contemplated that the particles can be subjected to a process of surface modification in which one or more type of polar groups are introduced to the carbon structure/scaffold. As will be recognized, such modification can be performed by associating the coal particles with a polymer that includes polar groups (e.g., using polyacrylic acid or polyvinyl alcohol in a polymer wrapping process), and more preferably by direct introduction of polar groups to the coal particles. Most typically, such direct introduction will comprise an oxidative process that may be thermally driven or that may use one or more strong oxidizing acids and/or other oxidizing agent. In still other embodiments, the direct introduction of polar groups may also use an electrochemical process or plasma gas exposure. Such polar groups may then assist in bonding to the casing and polar groups of a polymer.

Therefore, in a more general sense and where a viscosity agent is used, it is contemplated that the viscosity agent is typically present in the pumpable suspension in an amount of at least 0.01 wt %, at least 1 wt %, at least 5 wt %, at least 10 wt %, at least 20 wt %, at least 30 wt %, at least 40 wt %, at least 50 wt %, and even higher, based on the total wt % of the pumpable suspension. Thus, viscosity agents may be present in the range of between 0.01 wt % to 0.1 wt %, or between 0.1 wt % and 1 wt %, or between 1 wt % and 5 wt %, or between 5 wt % and 10 wt %, or between 10 wt % and 20 wt %, or between 20 wt % and 30 wt %, or between 30 wt % and 40 wt %, or between 20 wt % and 40 wt %, and even higher.

In short, contemplated high apparent viscosity carrier fluid will have a composition, i.e., comprises additives and/or a viscosity agent, that is effective to suspend the plurality of TRE particles until the viscosity of the carrier fluid is reduced by the triggering event in situ such as a change in chemical reactivity, or pH, or temperature, or time. In response to the reduction in viscosity, the TRE particles may begin to settle and form the settled particle sheath within the annular space of the wellbore. In terms of the specific TRE particles that may be used for formation of the high-thermal k settled particle sheath, and consequently the compacted particle sheath, it is generally contemplated that the TRE particles may include a plurality of, but are not limited to, graphite, sand, diamond, silver, gold, rhodium, palladium, titanium, carbon fiber, carbon black, Hastelloy, quartz silica, a carbon nanotube, graphene, boron nitride, brass, a brass alloy, chrome nickel steel, carbon steel, stainless steel, a transition metal (e.g., copper, cadmium, cobalt, gold, silver, iridium, iron, molybdenum, nickel, platinum, zinc, and the like), a transition metal alloy (e.g., a copper alloy, a cadmium alloy, a cobalt alloy, a gold alloy, a silver alloy, an iridium alloy, an iron alloy, a molybdenum alloy, a nickel alloy, a platinum alloy, a zinc alloy, an aluminum alloy and the like), a post-transition metal (e.g., lead, tin, and the like), a post-transition metal alloy (e.g., an lead alloy, a tin alloy, and the like), an alkaline earth metal alloy (e.g., a beryllium alloy, a magnesium alloy, and the like), oxides and nitrides of transition metals and post-transition metals, ceramic composites containing silicon and/or aluminum, or combinations thereof. In certain embodiments, the high-thermal k material is selected from the group consisting of graphite powder, exfoliated graphite, flaked graphite, pyrolytic graphite, desulfurized petroleum coke, graphene, fly ash, copper powder, aluminum nitride, alumina, silica, silicon carbide, and combinations thereof. Moreover, the particles may also include carbon-based inorganic, metal, metal oxides, metal nitrides, alloys, and/or hybrid materials, and in some embodiments, the TRE particles comprise at least two chemically distinct materials selected from the group listed above. However, it is preferred that any thermally conductive filler or active material known in the art can be used in the contemplated pumpable suspension. Along the same vein, contemplated TRE particles for use herein may have a thermal conductivity of at least 1.5 W/mK, at least 5 W/mK, at least 10 W/mK, at least 30 W/mK, at least 50 W/mK, at least 100 W/mK, at least 250 W/mK, at least 300 W/mK, or at least 400 W/mK.

Most typically, the TRE particles have a shape that may include, but is not limited to, a platelet, a flake, a sphere, an irregular shape, a cube, a rod, a disc, a prism, a needle, a tube, a fiber, an angular shape, a subangular shape, a rounded shape, a subrounded shape, a dumbbell shape, and a star shape. Where desired, a first portion and a second portion of the plurality of particles has a shape selected from the group listed above. Additionally, the shape of the first and second portions may be distinct. In some embodiments, to improve compaction, a first portion of the plurality of TRE particles have a composition and shape such that a mass of the first particles, upon compressional loading, deform elastically and plastically, and wherein a second portion of the particles have a composition and shape such that a mass of the second particles, upon the compressional loading, deform only elastically.

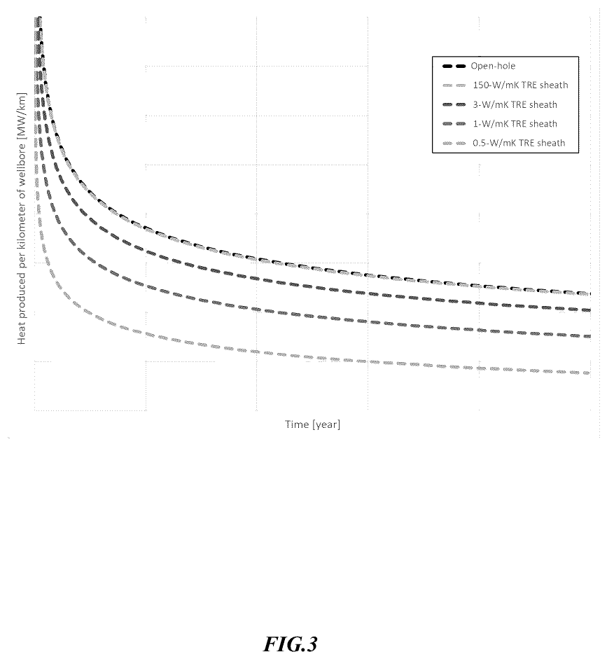

Advantageously, the networks of TRE particles from the settled particle sheath, and the optional TRE structures, may have a thermal conductivity that is at least twice, or at least three times, or at least five time, or at least 10 times, or at least 20 times the thermal conductivity of a rock formation in which the thermal reach enhancement system is located. For example, thermal conductivity of a rock formation can be in most typical examples between 0.5 and 5 W/m° K. Therefore, contemplated networks of the TRE structure and the settled particle sheath can have a thermal conductivity of at least 4 W/m° K, or at least 6 W/m° K, at least 8 W/m° K, at least 10 W/m° K, at least 15 W/m° K, at least 20 W/m° K, at least 30 W/m° K, at least 40 W/m° K, at least 50 W/m° K, at least 60 W/m° K, at least 70 W/m° K, and even higher. For example, contemplated networks of high thermal k particles with the TRE structure and/or the settled particle sheath can have a thermal conductivity of between 5 and 20 W/m° K, or between 10 and 30 W/m° K, between 25 and 50 W/m° K, between 40 and 75 W/m° K, etc. In other words, it is contemplated that to improve heat transfer from the hot formation to the working fluid in the casing, the settled and/or compacted sheath should not act as a thermal insulator but instead provide an effective conduit for thermal energy from the geological formation and/or TRE structure. The importance of the coefficient of thermal conductivity in the sheath can further be seen in the results of FIG. 3.

In various embodiments, the quantity of particles required to achieve a desired amount of thermal conductivity within the settled and/or compacted particle sheath may vary depending on the type and/or size of the particles. As will be readily appreciated, the particles may have an average D50 particle size of between 0.05 μm and 5.0 mm. Moreover, the particles may be in a form of a plurality of particles having a wide size distribution or a narrow size distribution. Suitable sizes for the high thermal k particles include sizes with the largest dimension of between about 10-50 nm, or between 50-250 nm, or between 250-1,000 nm, or between 1-20 μm, or between 20-200 μm, or between 200-750 μm, or between 750-2,000 μm, and even larger. Moreover, the first high thermal k particles will preferably have a relatively wide particle size distribution. Therefore, contemplated high thermal k particles can have a particle size distribution that spans at least 2.0 log units, or at least 2.5 log units, and even wider. Nonetheless, the plurality of TRE particles may have a size that allows settling of the TRE particles a distance of at least 1 m within 24 hours after reducing the viscosity of the high apparent viscosity carrier fluid. The amount of time necessary for the TRE settled particle sheath to form may vary depending on the resulting porosity. For example, sufficient settling time may be at least 12 hours, at least 24 hours, at least 36 hours, at least 48 hours, at least 72 hours, or at least 120 hours. Regardless of the amount of time necessary, it is preferable that the settled particle sheath has a final porosity of equal or less than 80%.

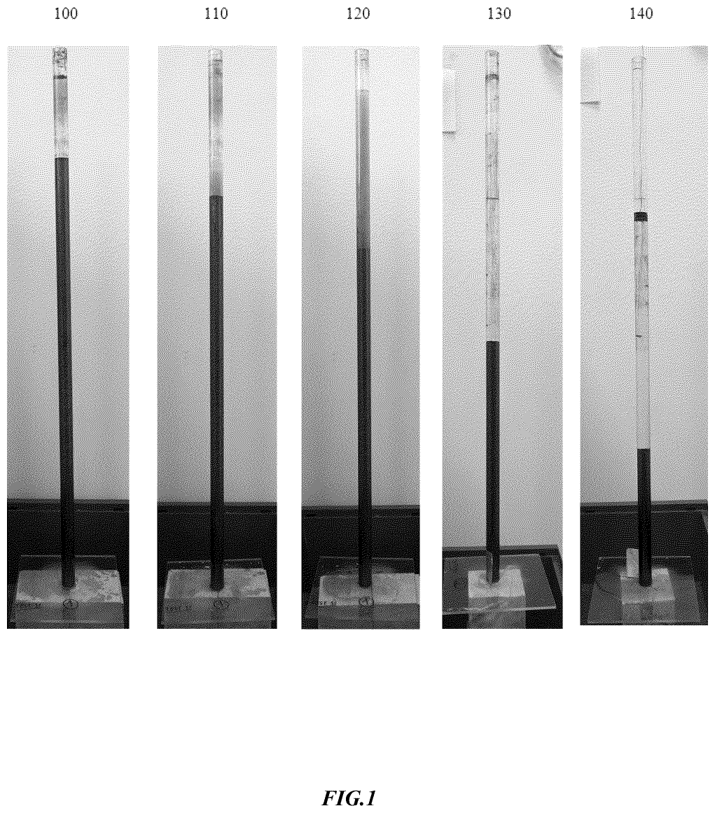

As shown in FIG. 1, after formation of the settled particle sheath 100, in order to improve heat transfer, the settled particle sheath can then be consolidated in various ways to form a compacted TRE sheath. The settled particle sheath may be consolidated using suction consolidation 110, or effective stress consolidation 120, or hydraulic consolidation 130, or hydraulic consolidation under pressure 140. Hydraulic consolidation may be used by draining and/or pumping the high apparent viscosity carrier fluid of the suspension away from the settled particle sheath. In some embodiments, chemical consolidation is performed by applying an effective stress of at least 10 psi, at least 15 psi, or at least 20 psi to the settled particle sheath. Such effective stress is applied either, as a result of the solids located above a given depth, in the same manner as geological formations consolidate when buried underground or of the application of a pressure above the column of solids, under the condition that an impermeable or semi-impermeable layer exists above the solids column to transform the pressure into effective stress.

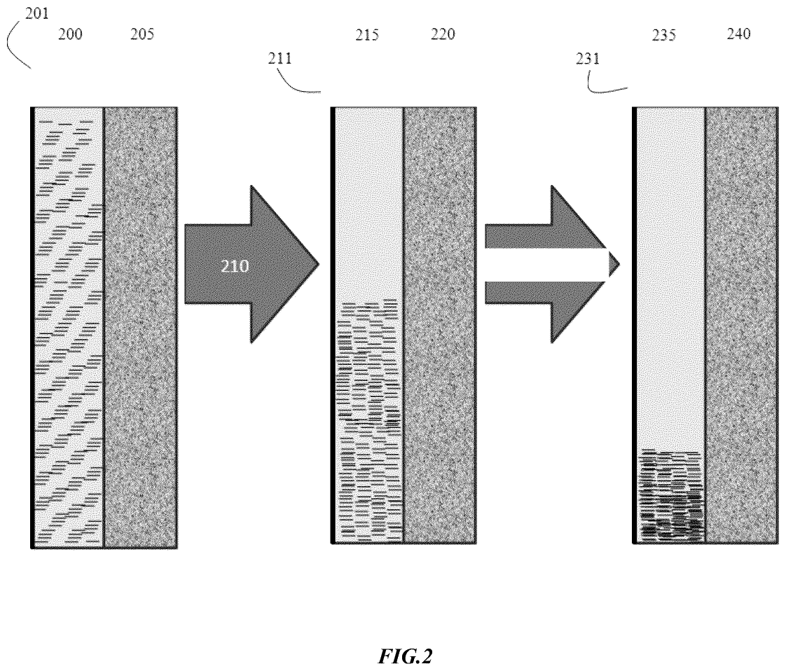

The effects of consolidation are further illustrated in FIG. 2. Upon placing the above discussed pumpable suspension into the annular space between the casing 201 and geological formation 205, the particles remain suspended 200 at the end of placement. The suspension is then broken 210 to allow the particles sufficient time to settle 215 in the annular space between the casing 211 and the geological formation 220. Lastly, there is a step of consolidation 230 via hydraulic consolidation and/or chemical consolidation where an increase in effective stress is applied to thereby form a resulting compacted TRE particle sheath 235, at the end of consolidation, between the casing 231 and the geological formation 240.

Consequently, after applying some form of consolidation to the settled particle sheath, the resulting compacted TRE sheath will have a permeability of equal or less than 0.01 Darcy. However, the compacted TRE sheath may alternatively have a permeability of equal or less 2 Darcy, or equal or less 5 Darcy, or equal or less 10 Darcy. Viewed from another perspective, after enhanced consolidation, a resulting compacted TRE sheath may have a final porosity of between 45%-55%, or between 50%-60%, or between 60% to 70%, or between 65% to 75%, or between 70% to 80%.

In terms of thermal conductivity, it is preferable that the settled particle sheath is consolidated to form a compacted sheath with a thermal conductivity of at least 1.5 W/mK, at least 3 W/mK, or at least 5 W/mK, or at least 10 W/mK, or at least 20 W/mK, or at least 50 W/mK, or at least 100 W/mK, or at least 200 W/mK, or at least 400 W/mK. Viewed from another perspective, the resulting high thermal conductivity compacted sheath may have a thermal conductivity of between 1.5 W/mK and 25 W/mK, or between 20 W/mK and 50 W/mK, or between 40 W/mK and 100 W/mK, or between 50 W/mK and 200 W/mK, or between 150 W/mK and 300 W/mK. In some embodiments, the compacted sheath comprises two different types of thermally conductive particles. However, regardless of the resulting thermal conductivity of the compacted sheath, it is contemplated that the high thermal conductivity sheath typically has a higher thermal conductivity as compared to the settled particle sheath.

In order to control the thermal conductivity of the resulting compacted particle sheath, the amount of the TRE particles that are present in the pumpable suspension may be adjusted to provide the desired amount of thermal conductivity. For example, the plurality of particles may be present in the pumpable suspension in an amount of at least 1 vol %, at least 10 vol %, at least 20 vol %, at least 30 vol %, at least 40 vol %, at least 50 vol %, at least 60 vol %, at least 70 vol %, at least 75 vol %, at least 89 vol %, at least 90 vol %, at least 91 vol %, at least 92 vol %, at least 93 vol %, at least 94 vol %, at least 95 vol %, at least 96 vol %, at least 97 vol %, at least 98 vol %, or at least 99 vol %, and even higher, based on total volume of the pumpable suspension. Alternatively, the plurality of TRE particles may be present in the pumpable suspension in an amount of from about 1 to about 99 vol %, from about 5 vol % to about 99 vol %, from about 40 vol % to about 99 vol %, or from about 80 vol % to about 99 vol %, based on a total volume of the suspension.

Where a TRE structure is implemented, the compacted TRE sheath may comprise a high thermal k material that can be distinguished from the high thermal k material of the proximal mouth portion of the TRE structure that is flush to the annular space of the wellbore. On one side, the compacted TRE sheath may be thermally coupled to the heat harvester casing. On the other side, the compacted TRE sheath is preferably thermally coupled to the high thermal k material of the TRE structure and optionally the high thermal material of a second TRE structure. In many embodiments, the high thermal conductivity compacted sheath extends, in multi-segmented portions, substantially vertically along at least 5%, at least 10%, at least 20%, at least 40%, at least 70%, or at least 85% of the vertical length of the target location. In such embodiments, each sheath segment of the compacted sheath may have a height of at least 3 m, at least 5 m, at least 10 m, at least 25 m, at least 50 m, at least 100 m, at least 200 m, at least 300 m, at least 400 m, or at least 500 m. Thus, a compacted multi-segment sheath may have an overall length of at least 50 m, or at least 100 m, or at least 200 m, or at least 500 m, or at least 750 m, or at least 1,000 m, or at least 2,000 m, or at least 3,000 m, or at least 4,000 m, each including between 2 and 5 segments, or 5-10 segments, or 10-50 segments, and even more.

Advantageously, the networks of TRE particles from the compacted particle sheath and the previously discussed TRE structure may have a thermal conductivity that is at least twice, or at least three times, or at least five time, or at least 10 time, or at least 20 times the thermal conductivity of a rock formation in which the thermal reach enhancement structure is located. For example, thermal conductivity of a rock formation can be in most typical examples between 0.5 and 5 W/m° K, and in some examples between 5 and 7 W/m° K, and in other examples between 7-10 W/m° K. Therefore, contemplated networks of the TRE structure and the compacted TRE sheath can have a thermal conductivity of at least 4 W/m° K, or at least 6 W/m° K, at least 8 W/m° K, at least 10 W/m° K, at least 15 W/m° K, at least 20 W/m° K, at least 30 W/m° K, at least 40 W/m° K, at least 50 W/m° K, at least 60 W/m° K, at least 70 W/m° K, and even higher. For example, contemplated networks of high thermal k particles with the TRE structure and/or the compacted particle sheath can have a thermal conductivity of between 5 and 20 W/m° K, or between 10 and 30 W/m° K, between 25 and 50 W/m° K, between 40 and 75 W/m° K, etc. In this context, it is generally preferred that the thermal conductivity of the TRE structure in the formation and the thermal conductivity of the compacted TRE particle sheath are relatively closely matched for long term power yield. For example, the thermal conductivity of the TRE structure and the compacted TRE particle sheath may differ by no more than 50%, or by no more than 30%, or by no more than 20%, or by no more than 10%, or by no more than 5%, or are the same. Moreover, it is generally preferred that where the thermal conductivities deviate, the thermal conductivity of the compacted TRE particle sheath is greater than the thermal conductivity of the TRE structure. Viewed from a different perspective, the compacted sheath most typically has a thermal conductivity that is the same as or differs no more than 10%, or no more than 20%, or no more than 30%, or no more than 40%, or no more than 50% of the thermal conductivity of the TRE structure to which it is thermally coupled.

The terms “compacted” as utilized herein means that the steps of settling and consolidation have been completed. For example, the compacted particle sheath has (a) a decreased water content in an amount of at least 1 wt. %, 2 wt. %, 3 wt. %, 4 wt. %, 5 wt. %, 10 wt. %, 15 wt. %, 20 wt. %, 30 wt. %, 40 wt. %, 50 wt. %, 60 wt. %, 70 wt. %, 80 wt. % 90 wt. %, or 99 wt. % as compared to the settled particle sheath prior to consolidation, (b) an increased density in an amount of at least 1 wt. %, 2 wt. %, 3 wt. %, 4 wt. %, 5 wt. %, 10 wt. %, 15 wt. %, 20 wt. %, 30 wt. %, 40 wt. %, 50 wt. %, 60 wt. %, 70 wt. %, 80 wt. % 90 wt. %, 100 wt. %, or even more as compared to the settled particle sheath prior to consolidation, or (c) both (a) the decreased water content and (b) the increased density.

Various configurations, systems, methods, and contemplations of installing a settled thermally conductive sheath are suitable for use herein, and especially contemplated configurations, systems, methods, and contemplations are disclosed in the concurrently filed international patent application “Systems and Methods to Place a Thermally Conductive Sheath in a Geothermal Well”, which is incorporated by reference in its entirety.

### Aspects

The present disclosure will be better understood upon reading the following numbered aspects which should not be confused with the claims. In some instances, each of the aspects described below can be combined with other aspects, including combined with other aspects described elsewhere in the disclosure or other aspects from the examples below, without departing from the spirit of the disclosure.

1. A pumpable suspension that comprises a mixture comprising a suspended thermal reach enhancement (TRE) solid and a high apparent viscosity carrier fluid; wherein the TRE solid is in the form of a plurality of TRE particles and the high apparent viscosity carrier fluid suspends the particles throughout the fluid; wherein the high apparent viscosity carrier fluid has a composition that allows an additive or triggering event to change physical and/or chemical properties of the mixture in situ to thereby reduce viscosity and thereby allow the particles to settle via gravity at a target location to form a settled particle sheath; and wherein the TRE particles have a composition that allows consolidation of the settled particle sheath to form a high-thermal conductivity compacted sheath within the annular space of a wellbore.

2. The suspension of aspect 1, wherein consolidation comprises hydraulic consolidation and/or chemical consolidation.

3. The suspension of any one of the preceding aspects, wherein the plurality of TRE particles comprise a material selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, cobalt, copper alloys, nickel, iron, platinum, palladium, tin, steel, zirconium, titanium, carbon fiber, carbon black, and Hastelloy, and optionally wherein the TRE particles comprise at least two chemically distinct particles selected from the group consisting zinc, graphite, graphene, tungsten, aluminum, silicon carbide, aluminum nitride, silicon nitride, boron nitride, gold, copper, silver, diamond, aluminum alloys, aluminum oxides, rhodium, cobalt, copper alloys, nickel, iron, platinum, palladium, tin, steel, zirconium, titanium, carbon fiber, carbon black, and Hastelloy.

4. The suspension of any one of the preceding aspects, wherein the compacted sheath has a thermal conductivity of greater than 1.5 W/mK.

5. The suspension of any one of the preceding aspects, wherein the TRE particles have a shape selected from the group consisting of a platelet, a flake, a sphere, an irregular shape, a cube, a rod, a disc, a prism, a needle, a tube, a fiber, an angular shape, a subangular shape, a rounded shape, a subrounded shape, a dumbbell shape, and a star shape.

6. The suspension of any one of the preceding aspects, wherein a first portion and a second portion of the plurality of TRE particles have a shape selected from the group consisting of a platelet, a flake, a sphere, an irregular shape, a cube, a rod, a disc, a prism, a needle, a tube, a fiber, an angular shape, a subangular shape, a rounded shape, a subrounded shape, a dumbbell shape, and a star shape, and wherein the shape of the first and second portions are distinct.

7. The suspension of any one of the preceding aspects, wherein a first portion of the plurality of TRE particles have a composition and shape such that a mass of the first particles, upon compressional loading, deforms elastically and plastically, and wherein a second portion of the TRE particles have a composition and shape such that a mass of the second particles, upon the compressional loading, deforms only elastically.

8. The suspension of any one of the preceding aspects, wherein the plurality of the TRE particles have D50 particle size of between 0.05 μm and 5.0 mm.

9. The suspension of any one of the preceding aspects, wherein the plurality of the TRE particles make up between 30 vol % and 70 vol % of the total suspension.

10. The suspension of any one of the preceding aspects, wherein the high apparent viscosity carrier fluid comprises a quantity of water.

11. The suspension of aspect 10, wherein the high apparent viscosity carrier fluid comprises a water-soluble biopolymer, water-soluble derivatized biopolymer, water-soluble gum, water-soluble cellulose, a water-soluble synthetic polymer, or a surfactant, and optionally, wherein the gum, cellulose, polymer, or biopolymer in the carrier fluid forms a network, is crosslinked, or form a supramolecular structure.

12. The suspension of aspect 11, wherein the gum, cellulose, polymer, or biopolymer bonds to the TRE particles and forms a suspended particle, a particle filled network, a crosslinked particle filled polymer network, or form a particle filled supramolecular structure.

13. The suspension of aspect 10, wherein the high apparent viscosity carrier fluid comprises a viscosity agent selected from the group consisting of a guar gum, polysaccharide (starch, guar, cellulose, cellulose derivatives, alginates, carrageenan, or locust gum), a Xanthan, hydroxylethyl cellulose (HEC), a carboxymethyl guar (CMG), carboxymethyl hydroxylethyl cellulose (CMHEC) a hyperbranched polyglycerol (HPG), a carboxymethyl hydroxypropyl guar (CMHPG), a carboxymethyl cellulose (CMC), a high strength molding compound (HMC), an acrylamide, a poly (acrylamide/acrylic acid/2-acrylamido-2-methylpropane sulfonic acid) (AMPS-AA-AM), and a viscoelastic surfactant (VES).

14. The suspension of aspect 13, wherein the viscosity agent is present in an amount of between 0.01 and 20 wt % of the pumpable suspension.

15. The suspension of any one of the preceding aspects, wherein the high apparent viscosity carrier fluid has a composition that allows reducing the viscosity with an additive selected from the group consisting of an oxidizer, a biobased enzyme, a bacterium, and a pH modifier, or that allows reducing the apparent viscosity with a shear force or temperature change.

16. The suspension of any one of the preceding aspects, wherein the triggering event is a change in pH or temperature, or time.

17. The suspension of any one of the preceding aspects, wherein the additive comprises between 0.001 and 10 wt % of the total suspension wt %.

18. The suspension of any one of the preceding aspects, wherein the additive modifies the temperature stability of the pumpable suspension.

19. The suspension of any one of the preceding aspects, wherein the pumpable suspension optionally further comprises a second additive that promotes the association of the plurality of TRE particles to a viscosity agent to thereby improve mixing and dispersion of the plurality of TRE particles within the high apparent viscosity carrier fluid.

20. The suspension of any one of the preceding aspects, wherein the pumpable suspension optionally further comprises a second additive that breaks a polymer backbone or a polymer-polymer crosslink, optionally in response to the triggering event.

21. The suspension of any one of the preceding aspects, wherein the pumpable suspension optionally further comprises a second additive that absorbs thermal energy to extend the usable temperature range for a given polymer by between 5° C. and 50° C.

22. The suspension of any one of the preceding aspects, wherein the additives are selected from the group consisting of a cross-linker additive, a dispersant additive, a breaker additive, and a stabilizer additive.

23. The suspension of aspect 22, wherein the cross-linker additive is aluminum, chromium, metal antimony, boron, titanium, or zirconium based.

24. The suspension of aspect 22, wherein the dispersant additive is a surfactant, a polymer, a salt, or a pH modifier.

25. The suspension of aspect 22, wherein the de-airing additive is a polydimethylsiloxane, an alcohol, a stearate, a glycol, a surfactant, an alkylphenol ethoxylate, a silicone defoamer, a mineral oil defoamer, a vegetable oil defoamer, a wax-based defoamer, a polymer defoamer, or a silicone-free defoamer.

26. The suspension of aspect 22, wherein the breaker additive is a pH modifier, an oxidizer, an enzyme, or a bacterium.

27. The suspension of aspect 22, wherein the stabilizer additive is an oxidizer or a gel.

28. The suspension of aspect 22, wherein the composition comprises at least two distinct additives.

29. The suspension of any one of the preceding aspects, wherein the high apparent viscosity carrier fluid suspends the plurality of TRE particles until the apparent viscosity of the carrier fluid is reduced by the triggering event in situ.

30. The suspension of any one of the preceding aspects, wherein the high apparent viscosity carrier fluid has a dynamic viscosity, before the triggering event, of at least 5,000 centipoises (cP), and a dynamic viscosity, after the triggering event, of no more than 1,000 cP.

31. The suspension of any one of the preceding aspects, wherein the plurality of TRE particles has a size that allows settling of the TRE particles a distance of at least 1 m within 24 hours after reducing the viscosity.

32. The suspension of any one of the preceding aspects, wherein the settled particle sheath has a thermal conductivity of between about 1.5 W/mK and 400 W/mK.

33. The suspension of any one of the preceding aspects, wherein the settled particle sheath has a final porosity of equal or less than 80%.

34. The suspension of any one of the preceding aspects, wherein the settled particle sheath is consolidated to have a permeability of equal or less than 0.01 Darcy.

35. A system configured to transfer heat from a geological formation to a heat harvester casing that comprises a heat harvester casing disposed in a wellbore that descends substantially vertically from a topside location to a target location in a geological formation; a thermal reach enhancement (TRE) structure at the target location that comprises a first high thermal k material; wherein the TRE structure extends from the wellbore distally into the geological formation at the target location, and wherein the TRE structure has a mouth portion at the wellbore; a high-thermal conductivity sheath comprising a multiple sheath segments along a vertical length of the high-thermal conductivity compacted sheath, that is thermally coupled to (a) an outer surface of the casing and substantially vertically extends along some of the length of the target location in the annular space of the wellbore, and (b) the mouth portion of the TRE structure to thereby form a continuous heat transfer path from the target location via the TRE structure and sheath to the casing.

36. The system of aspect 35, wherein the target location is at a depth of between 150 m and 20,000 m.

37. The system of any one of aspects 35-36, wherein the geological formation at the target location has a geostatic temperature of between 120° C. and 600° C.

38. The system of any one of aspects 35-37, wherein the TRE structure comprises a plurality of particles selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, cobalt, copper alloys, nickel, iron, platinum, palladium, tin, steel, zirconium, titanium, carbon fiber, carbon black, and Hastelloy, and optionally wherein the TRE structure comprises at least two chemically distinct particles selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, zinc, cobalt, copper alloys, nickel, iron, platinum, palladium, tin, steel, zirconium, titanium, carbon fiber, carbon black, and Hastelloy.

39. The system of any one of aspects 35-38, wherein the TRE structure has a width that decreases from the proximal mouth portion to the distal portion.

40. The system of any one of aspects 35-39, wherein the TRE structure extends longitudinally along the wellbore.

41. The system of any one of aspects 35-40, wherein the TRE structure has a width of between 1 mm and 100 mm.

42. The system of any one of aspects 35-41, wherein the TRE structure extends into the formation a longitudinal distance of between 1 and 200 m.

43. The system of any one of aspects 35-42, wherein the TRE structure has a bi-wing configuration.

44. The system of any one of aspects 35-43, wherein the TRE structure has a thermal conductivity of between 1.5 and 150 W/mK.

45. The system of any one of aspects 35-44, wherein a first high thermal k material of the proximal mouth portion of the TRE structure is flush to the annular space of the wellbore.

46. The system of any one of aspects 35-45, further comprising a second TRE structure that has a vertical offset from the TRE structure of between 10 m and 100 m.

47. The system of any one of aspects 35-46, further comprising a second TRE structure that has a radial offset from the TRE structure of between 15 degrees and 90 degrees.

48. The system of aspect 46 or aspect 47, wherein the second TRE structure comprises at least two chemically distinct particles selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, cobalt, copper alloys, nickel, iron, platinum, palladium, tin, steel, zirconium, titanium, carbon fiber, carbon black, and Hastelloy.

49. The system of any one of aspects 35-48, wherein the compacted sheath has a thermal conductivity of between about 1.5 W/mK and 50 W/mK, or between about 30 W/mK and 400 W/mK.

50. The system of any one of aspects 35-49, wherein each sheath segment of the compacted sheath has a height of between 3 m and 500 m.

51. The system of any one of aspects 35-50, wherein the compacted sheath comprises two different types of thermally conductive particles.

52. The system of any one of aspects 35-51, wherein the compacted sheath extends substantially vertically along between 10% and 70% of the target location.

53. The system of any one of aspects 35-52, wherein the compacted sheath has a thermal conductivity that is equal or differs no more than 50% of the thermal conductivity of the TRE structure.

54. The system of any one of aspects 35-53, wherein the compacted sheath has a thermal conductivity that is equal or differs no more than 30% of the thermal conductivity of the TRE structure.

55. The system of any one of aspects 35-54, wherein the compacted sheath has a thermal conductivity that is equal or differs no more than 10% of the thermal conductivity of the TRE structure or are the same.

56. A system configured to transfer heat from a geological formation to a heat harvester casing that comprises a heat harvester casing disposed in a wellbore that descends substantially vertically from a topside location to a target location in a geological formation; a high-thermal conductivity compacted sheath comprising multiple sheath segments along a vertical length of the high-thermal conductivity compacted sheath, that is thermally coupled to (a) an outer surface of the casing and substantially vertically extends along some of the length of the target location in an annular space of the wellbore, and (b) the target location in the geological formation to thereby form a continuous heat transfer path from the target location via the high-thermal conductivity compacted sheath to the casing.

57. The system of aspect 56, wherein the target location is at a depth of between 150 m and 20,000 m.

58. The system of any one of aspects 56-57, wherein the geological formation at the target location has a geostatic temperature of between 120° C. and 600° C.

59. The system of any one of aspects 56-58, wherein the compacted sheath has a thermal conductivity of between about 1.5 W/mK and 50 W/mK, or between about 30 W/mK and 400 W/mK.

60. The system of any one of aspects 56-59, wherein each sheath segment of the compacted sheath has a height of between 3 m and 500 m.

61. The system of any one of aspects 56-60, wherein the compacted sheath comprises two different types of thermally conductive particles.

62. The system of any one of aspects 56-61, wherein the compacted sheath extends substantially vertically along between 10% and 70% of the target location.

In some embodiments, the numbers expressing quantities of ingredients, properties such as concentration, reaction conditions, and so forth, used to describe and claim certain embodiments of the invention are to be understood as being modified in some instances by the term “about.” As used herein, the terms “about” and “approximately”, when referring to a specified, measurable value (such as a parameter, an amount, a temporal duration, and the like), is meant to encompass the specified value and variations of and from the specified value, such as variations of +/−10% or less, alternatively +/−5% or less, alternatively +/−1% or less, alternatively +/−0.1% or less of and from the specified value, insofar as such variations are appropriate to perform in the disclosed embodiments. Thus, the value to which the modifier “about” or “approximately” refers is itself also specifically disclosed. The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. As also used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C . . . and N, the text should be interpreted as requiring only one element from the group, not A plus N, or B plus N, etc.

What is claimed is:

1. A pumpable suspension, comprising:
a mixture comprising a suspended thermal reach enhancement (TRE) solid and a high apparent viscosity carrier fluid;
wherein the TRE solid is in the form of a plurality of TRE particles and the high apparent viscosity carrier fluid suspends the particles throughout the fluid;
wherein the high apparent viscosity carrier fluid has a composition that allows an additive or triggering event to change physical and/or chemical properties of the mixture in situ to thereby reduce viscosity and thereby allow the particles to settle via gravity at a target location to form a settled particle sheath within an annular space of a wellbore; and
wherein the TRE particles have a composition that allows consolidation of the settled particle sheath to form a high-thermal conductivity compacted sheath within the annular space of a wellbore.

2. The suspension of claim 1, wherein consolidation comprises hydraulic consolidation and/or chemical consolidation of the TRE particles.

3. The suspension of claim 1, wherein the plurality of TRE particles comprise a material selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, zinc, cobalt, copper alloys, nickel, iron, platinum, palladium, tin, steel, zirconium, titanium, carbon fiber, carbon black, and Hastelloy, and optionally wherein the TRE particles comprise at least two chemically distinct particles selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, zinc, cobalt, copper alloys, nickel, iron, platinum, palladium, tin, steel, zirconium, titanium, carbon fiber, carbon black, and Hastelloy.

4. The suspension of claim 1, wherein the compacted sheath has a thermal conductivity of greater than 1.5 W/mK.

5. The suspension of claim 1, wherein a first portion and a second portion of the plurality of TRE particles have a shape selected from the group consisting of a platelet, a flake, a sphere, an irregular shape, a cube, a rod, a disc, a prism, a needle, a tube, a fiber, an angular shape, a subangular shape, a rounded shape, a subrounded shape, a dumbbell shape, and a star shape, and wherein the shape of the first and second portions are distinct and/or wherein a first portion of the plurality of TRE particles have a composition and shape such that a mass of the first particles, upon compressional loading, deforms elastically and plastically, and wherein a second portion of the TRE particles have a composition and shape such that a mass of the second particles, upon the compressional loading, deforms only elastically.

6. The suspension of claim 1, wherein the plurality of the TRE particles have D50 particle size of between 0.05 μm and 5.0 mm and/or wherein the plurality of the TRE particles make up between 10 vol % and 75 vol % of the total suspension.

7. The suspension of claim 1, wherein the high apparent viscosity carrier fluid comprises a quantity of water and optionally further comprises a water-soluble biopolymer, a water-soluble derivatized biopolymer, a water-soluble gum, a water-soluble cellulose, a water-soluble synthetic polymer, or a surfactant, and optionally, wherein the gum, the cellulose, the polymer, or the biopolymer in the carrier fluid forms a network, is crosslinked, or forms a supramolecular structure.

8. The suspension of claim 10, wherein the high apparent viscosity carrier fluid further comprises a viscosity agent selected from the group consisting of a guar gum, a polysaccharide (starch, guar, cellulose, cellulose derivatives, alginates, carrageenan, or locust gum), a xanthan, hydroxylethyl cellulose (HEC), a carboxymethyl guar (CMG), carboxymethyl hydroxylethyl cellulose (CMHEC) a hyperbranched polyglycerol (HPG), a carboxymethyl hydroxypropyl guar (CMHPG), a carboxymethyl cellulose (CMC), a high strength molding compound (HMC), an acrylamide, a poly (acrylamide/acrylic acid/2-acrylamido-2-methylpropane sulfonic acid) (AMPS-AA-AM), and a viscoelastic surfactant (VES).

9. The suspension of claim 1, wherein the high apparent viscosity carrier fluid has a composition that allows reducing the apparent viscosity with an additive selected from the group consisting of an oxidizer, a biobased enzyme, a bacterium, and a pH modifier, or that allows reducing the viscosity with a shear force or temperature change.

10. The suspension of claim 1, wherein the triggering event is a change in pH or temperature, or time and/or wherein the additive is selected from the group consisting of a cross-linker additive, a dispersant additive, a breaker additive, a de-airing additive, and a stabilizer additive.

11. The suspension of claim 1, wherein the high apparent viscosity carrier fluid has a dynamic viscosity, before the triggering event, of at least 5,000 centipoise (cP), and a dynamic viscosity, after the triggering event, of no more than 1,000 cP.

12. The suspension of claim 1, wherein the plurality of TRE particles have a size that allows settling of the TRE particles a distance of at least 1 m within 24 hours after reducing the viscosity.

13. The suspension of claim 1, wherein the settled particle sheath has a final porosity of equal or less than 80% and/or is consolidated to have a permeability of equal or less than 0.01 Darcy.

14. A system configured to transfer heat from a geological formation to a heat harvester casing, comprising:
a heat harvester casing disposed in a wellbore that descends substantially vertically from a topside location to a target location in a geological formation;
a thermal reach enhancement (TRE) structure at the target location that comprises a first high thermal k material;
wherein the TRE structure extends from the wellbore distally into the geological formation at the target location, and wherein the TRE structure has a proximal mouth portion at the wellbore;
a high-thermal conductivity compacted sheath comprising multiple sheath segments along a vertical length of the high-thermal conductivity compacted sheath, that is thermally coupled to
(a) an outer surface of the casing and substantially vertically extends along some of the length of the target location in an annular space of the wellbore, and
(b) the mouth portion of the TRE structure to thereby form a continuous heat transfer path from the target location via the TRE structure and compacted sheath to the casing; and
wherein the compacted sheath has a thermal conductivity of between about 1.5 w/mK and 50 W/mK or between about 30 W/mK and 400 W/mK.

15. The system of claim 14, wherein the target location is at a depth of between 150 m and 20,000 m and/or wherein the geological formation at the target location has a geostatic temperature of between 120° C. and 600° C.

16. The system of claim 14, wherein the first high thermal k material of the proximal mouth portion of the TRE structure is flush to the annular space of the wellbore.

17. The system of claim 14, wherein the compacted sheath extends substantially vertically along between 10% and 70% of the target location, and/or wherein each sheath segment of the compacted sheath has a height of between 3 m and 500 m.

18. The system of claim 14, wherein the compacted sheath has a thermal conductivity that is equal or differs no more than 50%, no more than 30%, no more than 10% of the thermal conductivity of the TRE structure or are the same.

19. A system configured to transfer heat from a geological formation to a heat harvester casing, comprising:
a heat harvester casing disposed in a wellbore that descends substantially vertically from a topside location to a target location in a geological formation;
a high-thermal conductivity compacted sheath comprising multiple sheath segments along a vertical length of the high-thermal conductivity compacted sheath, that is thermally coupled to
(a) an outer surface of the casing and substantially vertically extends along some of the length of the target location in an annular space of the wellbore, and
(b) the target location in the geological formation to thereby form a continuous heat transfer path from the target location via the high-thermal conductivity compacted sheath to the casing; and
wherein the compacted sheath has a thermal conductivity of between about 1.5 w/mK and 50 W/mK or between about 30 W/mK and 400 W/mK.

20. The system of claim 19, wherein the target location is at a depth of between 150 m and 20,000 m and/or the geological formation at the target location has a geostatic temperature of between 120° C. and 600° C., and/or wherein each sheath segment of the compacted sheath has a height of between 3 m and 500 m.
